(19) United States
(12) Patent Application Publication
(10) Pub. No.: US 2024/0003777 A1
(43) Pub. Date: Jan. 4, 2024

(54) ACOUSTIC EMISSION SENSOR, APPARATUS AND METHOD USING MECHANICAL AMPLIFICATION

(71) Applicant: OMNIA INTEGRITY LTD, London (GB)

(72) Inventors: Alessandro DEMMA, London (GB); Alessandro BORDIGNON, London (GB)

(21) Appl. No.: 18/247,593

(22) PCT Filed: Oct. 1, 2021
(86) PCT No.: PCT/GB2021/052552

§ 371 Date: Mar. 31, 2023

(30) Foreign Application Priority Data
Oct. 2, 2020 (GB) 2015639.4

(51) Int. Cl. G01M 7/02

(52) U.S. Cl. CPC G01M 7/025

(57) ABSTRACT

An acoustic emission (AE) sensor (10) comprises a vibration-sensing element and a mechanical amplifier (2). The mechanical amplifier is provided in the form of a metal plate, said metal plate having a width which is at least 2.5 times greater than any widths associated with the vibration-sensing element, and an area which is at least (5) times greater than any corresponding areas associated with the vibration-sensing element. The mechanical amplifier (2) is dynamically coupled to the vibration-sensing element, upstream of the vibration-sensing element. In this manner, the width and area 4, 5 of the mechanical amplifier (2) are specified so as to increase a signal-to-noise ratio of an AE signal (6) output by the AE sensor (10) in response to acoustic emission (7) generated by a target AE source (8). The AE sensor (10) shows, therefore, an improved sensitivity to the target AE source (8).

### TECHNICAL FIELD

The present invention concerns an Acoustic Emission (AE) sensor. The present invention also concerns related AE apparatus and related AE methods. More particularly, the present invention relates to an AE sensor, apparatus and/or methods for non-destructive testing applications, such as for detecting acoustic emission from an AE source located within a structure, such as a storage facility, or for geophysical applications, such as for detecting acoustic emission form an AE source located underground, or for sonar applications, such as for detecting acoustic emission from a seabed or from fish.

### BACKGROUND

Acoustic Emission (AE) is a non-destructive testing technique for testing, monitoring and/or otherwise assessing and/or evaluating the integrity of structures. A stress wave created locally by a change in a local condition of a medium located in the structure, or of a material which is part of the structure itself, can travel along the structure or via the medium present in the structure (such as a liquid or a gas, including air) to an AE sensor that can therefore detect a corresponding event (hereinafter, an “AE event”). AE sensors may thus pick up acoustic emissions, and this ability is the focus of the AE applications of present interest.

If an array of sensors is used, then the location of an AE source can be identified using triangulation algorithms, normally based on the arrival times of the acoustic emissions.

One of the key parameters that describe the ability of AE to carry out successful detection of AE signals is referred to as signal-to-noise ratio (i.e. “S/N ratio”). A useable AE signal will need to have sufficient amplitude above a baseline noise level at one or more frequencies being considered, so that the corresponding AE event can be ‘listened to’ above a noise threshold.

Dedicated electronics (internal or external to the AE sensors) is generally used to enable the detection and the recording of such events, for example on a computer. One possibility is to use a preamplifier (often situated inside the AE sensor) to electronically amplify noisy AE signals. However, the underlying AE signal may be so poor that preamplification may not be able to boost the S/N ratio adequately.

It may therefore be a challenge to detect AE events emitting at frequencies in the frequency spectrum of the background noise. Selection of the ‘best’ frequencies for carrying out the examination, therefore, does not depend only on the frequency spectrum emitted by the AE source to be listened to, but also on the frequency spectrum of the background noise. It would be desirable to have AE events with frequencies as far away as possible from those of any peaks in the background noise; however, this is not always possible, or practical.

It is also a challenge to detect relatively low amplitude AE signals generated by AE events emanating from AE sources located within an environment with limited access. For example, because of radiation safety concerns, within a nuclear waste storage facility the AE source of interest may be located at least several tens of meters away from a limited number of available locations where one or more AE sensors could be placed. This presents potential major issues related to the attenuation of the sound in air, which is mainly due to the spread of the acoustic beam emanating from the AE source, but also to the attenuation of sound in the propagation medium, even in air.

Accordingly, there is a need for an improved AE sensor with respect to those described in the prior art. In particular, there is a need for an AE sensor exhibiting an improved S/N ratio, at least at certain frequencies.

### SUMMARY OF THE INVENTION

According to an implementation of the present disclosure, there is provided an acoustic emission (AE) sensor comprising a vibration-sensing element and a mechanical amplifier comprising a metal plate, wherein the metal plate is dynamically coupled to the vibration-sensing element upstream of the vibration-sensing element, as defined in claim 1. Accordingly, certain geometric dimensions of the mechanical amplifier, that is a width and an area of the metal plate, are specified so as to increase a signal-to-noise ratio of an AE signal output by the AE sensor in response to acoustic emission generated by a target AE source.

The target AE source may have known characteristics, for example a known frequency spectrum, or an expected frequency spectrum. The known or expected frequency spectrum may be within defined amplitude limits at one or more of the frequency components contained in the spectrum.

The mechanical amplifier comprises a metal plate which may, in principle, take various shapes, and be made of any suitable metals. Further, the mechanical amplifier may be a single part, or be obtained by assembling multiple parts.

As used herein, the attribute “mechanical” is used in contraposition to “electric” or “electronic”, meaning that the mechanical amplifier may be any metal plate capable of mechanically amplifying at least certain components of a dynamic force exciting the AE sensor, such as an acoustic wave propagating from the AE source and received by said AE sensor.

The mechanical amplifier is said to be dynamically coupled to the vibration-sensing element of the AE sensor in that mechanical vibrations can be transmitted from the mechanical amplifier to the vibration-sensing element, directly or indirectly, that is via one or more other intervening structures or layers.

Further, the vibration behaviour of plates, such as that of thin plates, or ‘membranes’—for example thin plates or membranes having a uniform thickness, for example 10 or more times smaller than a radius, side, diagonal, diameter or other transversal dimension (depending on the shape) of the thin plate or of the membrane—is well characterized in scientific literature, which fact may help to specify suitable shapes, materials and/or dimensions of the plates, depending on the expected acoustic characteristics of the target AE source or sources.

The metal plate has a width at least 2.5 times greater than a corresponding width of the vibration-sensing element of the AE sensor. With ‘corresponding’ we mean that the width of the metal plate and that of the vibration-sensing element are measured with reference to corresponding features of the metal plate and the vibration-sensing element, such as corresponding faces thereof. These faces will generally be parallel one to the other, and be disposed perpendicularly with respect to an axial or longitudinal direction defined by the AE sensor.

Preferably, the metal plate is planar. However, alternatively, the metal plate may be curved; for example, it may be parabolic or concave along a direction, such as said axial or longitudinal direction. The plate may be designed to match a curvature of a curved structure to be inspected, such as a storage tank.

Preferably, the plate is in the shape of an ovoid, with a circle, i.e. a disc, being a possibility.

Preferably, it is a diameter of said ovoid or circle/disc that is at least 2.5 times greater than any other corresponding diameter associated with the AE sensor, such as a diameter of the vibration-sensing element, or a diameter of a face, body or other part of the AE sensor, for example.

The metal plate in addition has an area at least 5 times greater than a corresponding area of the vibration sensing element. This means that the metal plate acts as a collector of acoustic energy incoming from the AE source, and that said energy is modally converted by the metal plate for transmission to the vibration-sensing element. The area of the metal plate may be 5 times greater than any other corresponding areas associated with the AE sensor, such as the area of a face, a body or other part of the AE sensor.

Preferably, the width and area of the metal plate are specified to amplify one or more first frequencies of a frequency spectrum of sound waves generated by the target AE source.

Additionally, or alternatively, the width and area of the metal plate are specified to attenuate one or more second frequencies of the frequency spectrum of the sound waves generated by the target AE source.

Preferably, a thickness of the metal plate is uniform. This facilitates the specification of the metal plate, and thus of the mechanical amplifier of the AE sensor.

Preferably, the AE sensor comprises a housing for accommodating the vibration-sensing element, and the metal plate is integrated into said housing, such as assembled to or installed on said housing. For example, the housing may comprise an attachment means, such as a flange, for connection with the metal plate.

Preferably, the metal plate is dynamically coupled to a face or other portion, such as a suitably flat portion, of said housing, optionally, by means of an adhesive, or another coupling layer or element.

Alternatively, the metal plate may be integrally formed with the housing as a single piece, that is without showing material discontinuities between the mechanical amplifier and the remainder of the housing.

In some proposed implementations, the AE sensor may comprise a layered construction, i.e. a stack, or plurality of layers, wherein the metal plate and the vibration-sensitive element define respective layers within said layered construction or stack.

Preferably, said vibration-sensing element is piezoelectric.

Preferably, the vibration-sensing element is made of polyvinylidene fluoride.

Optionally, said layered construction or stack comprises a magnetic layer for attaching the AE sensor to a surface.

Optionally, the layered construction comprises a compliance layer for coupling the AE sensor to said surface.

Optionally, the compliance layer is a polymer, such as a rubber.

Preferably, the metal plate is constructed and arranged to shield the AE sensor against nuclear radiation.

Optionally, the mechanical amplifier may be replaceable.

According to another implementation of the present disclosure, there is provided an AE apparatus comprising the AE sensor described herein.

Preferably, the AE apparatus is passive. In ‘passive’ AE applications, the sound propagates directly from the target AE source after the occurring of a corresponding AE event. On the contrary, in ‘active’ AE applications, the sound propagating from the target AE source is reflected or refracted by the target AE source, but originates from a different source, such as a sonic or ultrasonic excitation source.

According to another implementation of the present disclosure, there is provided a method of detecting acoustic emission from a target AE source, the method comprising:
deploying the AE sensor described herein or the AE apparatus described herein.

Preferably, the AE sensor is deployed in a fluid medium, such as a gas or a liquid; alternatively, the AE sensor may be deployed in, within or on a solid medium.

According to another implementation of the present disclosure, there is provided a non-destructive testing method comprising the method described herein. Examples include inspecting a nuclear facility, such as a nuclear waste storage facility, and inspecting a storage tank.

According to another implementation of the present disclosure, there is provided a geophysical inspection method comprising the method described herein.

According to another implementation of the present disclosure, there is provided a sonar inspection method comprising the method described herein.

According to another implementation of the present disclosure, there is provided a method of retrofitting an AE sensor, the method comprising:
providing an AE sensor; and
fitting a mechanical amplifier to the AE sensor, wherein the mechanical amplifier is as described herein.

According to another implementation described herein, there is provided a combination of an AE sensor and a mechanical amplifier, the mechanical amplifier comprising a metal plate, said metal plate having a width which is at least 2.5 times greater than any corresponding widths associated with a vibration-sensing element of the AE sensor, and an area which is at least 5 times greater than any corresponding areas of the vibration-sensing element, wherein the mechanical amplifier is dynamically coupled or couplable to the vibration-sensing element upstream of the vibration-sensing element, and wherein said width and area of the metal plate are specified to increase a signal-to-noise ratio of an AE signal output by the AE sensor in response to acoustic emission generated by a target AE source.

According to another implementation of the present disclosure, there is provided a method of measuring acoustic emission, the method comprising:
providing an AE sensor;
specifying a width and an area for a mechanical amplifier so as to increase a signal-to-noise ratio of an AE signal output by the AE sensor in response to acoustic emission generated by a target AE source, wherein the mechanical amplifier is in the form of a metal plate having a width which is at least 2.5 times greater than any corresponding widths associated with a vibration-sensing element of the AE sensor, and an area which is at least 5 times greater than any corresponding areas of the vibration-sensing element;
independently of the provision of the AE sensor, providing said mechanical amplifier; and,
dynamically coupling the mechanical amplifier to the vibration-sensing element by fitting the mechanical amplifier to the AE sensor.

Illustrative implementations of the present concepts will now be described, by way of example only, with reference to the accompanying drawings, in which:

### LIST OF FIGURES

FIG. 1 is an elevation of an AE sensor according to a described implementation;

FIG. 2 is a top plan view of the AE sensor of FIG. 1;

FIG. 3 represents an experimental setup used for testing the performance of the AE sensor of FIGS. 1 and 2;

FIG. 4 is a comparison between S/N ratios measured by the AE sensor of FIGS. 1 and 2 and an AE sensor of the prior art across repeated tests using the setup of FIG. 3;

FIG. 5 is a frequency spectrum of the target AE source used in the setup shown in FIG. 3, measured by the prior art AE sensor referred to in the description of FIG. 4;

FIG. 6 is the frequency spectrum of the target AE source used in the setup shown in FIG. 3, but measured using the AE sensor of FIGS. 1 and 2;

FIG. 7 represents an application of the AE sensor of FIGS. 1 and 2 to the monitoring of a liquid storage tank; and,

FIG. 8 represents an application of an array of three AE sensors each according to FIGS. 1 and 2 for the detection of ground-propagating acoustic waves.

Throughout the description and the drawings, like reference numerals are used to identify like features across different implementations described herein.

Features described in connection with any one or more of the specific implementations described herein may be equally applicable to the other implementations, unless expressly stated otherwise.

### DESCRIPTION

The inventors set out to investigate whether the idea of providing a form of mechanical amplification to incoming acoustic emission waves upstream of an ordinary AE sensor would be advantageous.

It should be stressed that the above concept is in addition to any amplification (whether electrical or mechanical) that may already be provided in any ordinary AE sensors, i.e. as part of the design of these sensors. The mechanical amplification which is the subject of the present application is based on the concepts of, in first place increasing the energy that would be collected by an ordinary AE sensor from any AE sources, and, in second place, transforming that collected energy in resonant waves that propagate across the mechanical amplifier described herein, and from there to the ordinary AE sensor, with the objective of improving the S/N ratio output by the ordinary AE sensor, for a given AE source.

The idea was to devise a new AE sensor that could mechanically amplify the amplitude of at least certain frequency components of the received acoustic waves relative to the background noise, before the waves would be transmitted to a vibration-sensing element included in the AE sensor. This principle would result into amplified AE signals produced by the new AE sensor in response to the same received acoustic waves, with an improved S/N ratio.

The new AE sensor would thus exploit the mechanical properties and wave propagation characteristics of an intermediate structure placed on the propagation path of the acoustic waves to effectively create mechanical amplification, but tailored to the AE source.

Such intermediate structure would in addition help to create a barrier for protecting the sensor, for example from nuclear radiation effects if the application involved inspecting nuclear storage facilities stocking potentially radioactive waste.

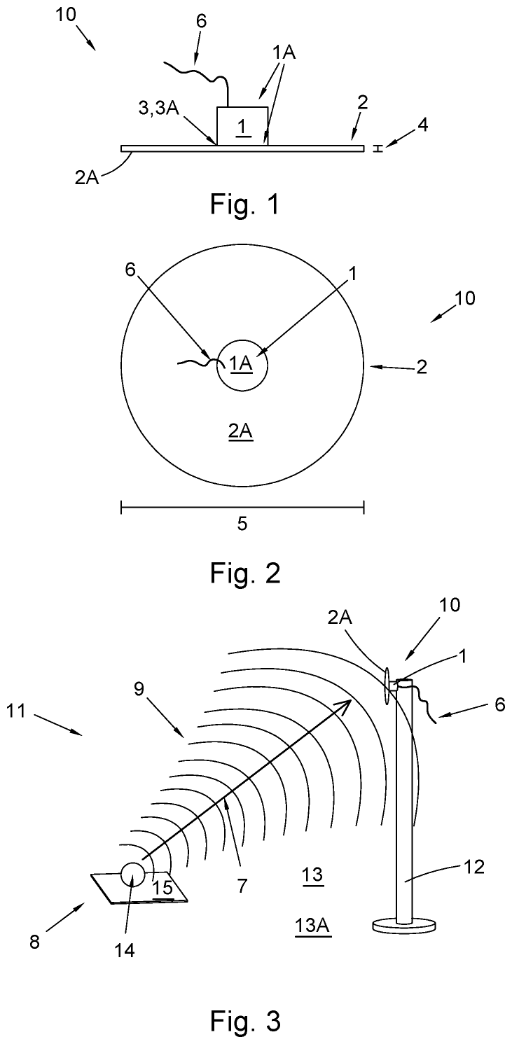

An implementation of a modified AE sensor 10 is schematically shown in FIGS. 1 and 2. This new AE sensor 10 comprises a standard AE sensor 1, of a type that can normally be found currently in the market, attached to a mechanical signal amplifier 2, which in the present implementation takes the form of a metal plate 2A, via a layer of an adhesive 3A.

It should be noted that the adhesive 3A could be replaced, for example, by a welding layer obtained via a suitable welding process. More generally, therefore, it is possible to consider the adhesive 3A as an example of a suitable coupling layer 3. Coupling between the ordinary AE sensor 1 and the metal plate 2A could have been achieved in a number of different manners.

The ordinary AE sensor 1 used in the present implementation was a Vallen Systeme VS30-SIC-46 dB. This is a piezoelectric AE sensor 1 with an integrated preamplifier of 46 dB gain. This sensor has a diameter of 28.6 mm and a height of 51.8 mm, and weights 170 g. The case is made of stainless steel, with a ceramic wear plate. However, the same tests and a similar implementation would have been possible starting from a different AE sensor 1. For example, it would have been possible to use a Vallen Systeme VS12-E, which has a generally lower frequency response. This is also a piezoelectric AE sensor 1, but without an integrated preamplifier. This sensor has a depth of 20.3 mm and a height of 59.0 mm, and weights 154 g. The case is also made of stainless steel, and the sensor also comes with a ceramic wear plate.

The metal plate 2A used herein is planar and circular, as shown in FIGS. 1 and 2, i.e. it is in the shape of a circular plate or disc. In the described implementation, the diameter of the metal plate 2A is around 4.5 times the diameter of a face 1A of the ordinary AE sensor 1 used herein (this can be measured on the wear plate of the AE sensor 1, or on the outer body). The metal plate 2A showed a very desirable, though initially surprising and unexpected (as the metal plate had been initially thought as a shielding structure to protect the AE sensor 1), AE signal amplification effect, which will be described further below.

Although the shape of the metal plate 2A is circular, the same amplification effect could have been obtained using a different shape. Both square and circular plate shapes were tested (made of the same material), having similar geometric dimensions. Both metal plates 2A resulted in an increased amplitude of the AE signal 6 produced by the new AE sensor 10, when compared to the ordinary AE sensor 1 in isolation, i.e. without the metal plate 2.

A first principle of the implementation described herein, therefore, is the observed amplification of the amplitude in the time domain of the AE signal 6 output by the new AE sensor 10, which can be explained by the metal plate 2A, which is dynamically coupled to a vibration-sensing element (not shown) included in the new AE sensor 10, acting effectively as a collector element capable of collecting a larger portion of the incoming energy from the target AE source 8 compared to the case of the old AE sensor 1 in isolation, i.e. without the metal plate collector.

The same effect could in principle be achieved by building a larger AE sensor 1, but this would be very costly due to current limitations in size in relation to materials used for making the vibration-sensing element, such as piezoelectric materials, which are located inside all AE sensors. Further, larger AE sensors may generally be unacceptable, for example due to the extra space they occupy or because of their extra weight and difficulties in handling.

FIG. 3 schematically illustrates a setup 11 used to carry out tests with a view to validating the present concepts. The setup 11 included affixing the new AE sensor 10 to a post 12, which post 12 was suitably placed to receive acoustic emission 9 from a target AE source 8 propagating through air 13A as the wave propagation medium 13. The post 12 was located around 4 metres away from the target AE source 8, in this setup.

In the present tests, since the orientation of the target AE source 8 was known, the metal plate 2A could have been placed generally perpendicularly to the direction of propagation 7 of the sound waves 9 coming from the AE source 8 so as to increase the energy impacting on the metal plate 2A. However, other orientations were also deemed to be effective, as for example that which is shown in FIG. 3.

It will be appreciated that other propagation media 13 would be possible in other implementations of the present principles, such as liquids or solids (as further described below).

In the present tests, a metal sphere 14 of about 500 g was dropped on a metal sheet 15 from a height of about one metre. The ensuing acoustic emissions 9 were detected and transduced by the new AE sensor 10 placed on said post 12, as shown.

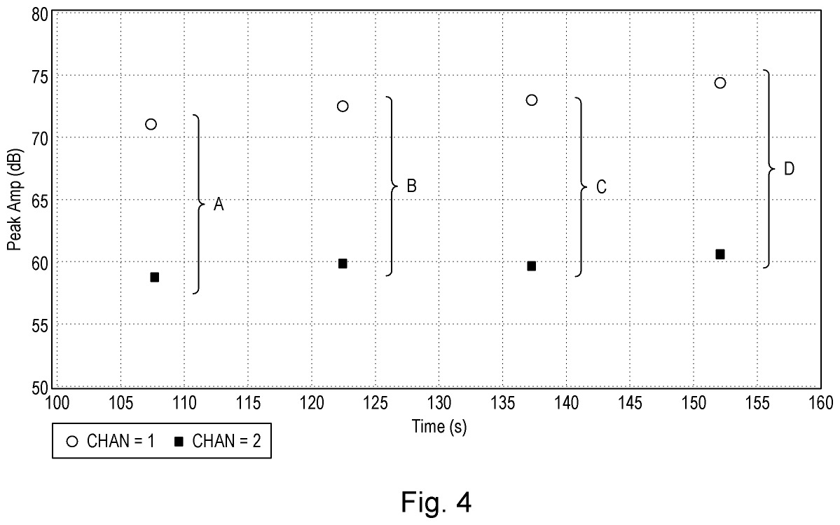

FIG. 4 shows graphically the results of four comparison tests (A, B, C and D), where an ordinary AE sensor 1 and a new AE sensor 10 based upon the ordinary AE sensor 1 were used to record the same acoustic events, four times, at different time instants. The new AE sensor 10 included the ordinary AE sensor 1 attached by means of an adhesive to a 3 mm thick, 125 mm diameter steel plate 2A, of circular shape, as described earlier. The impact between the metal sphere 14 and the large metal sheet 15 generated repeatable AE events. The same frequency filtering and other signal processing options were used for the sole AE sensor 1 and the new AE sensor 10. Both the AE sensor 1 and the new AE sensor 10 were placed on the same post 12, close to each other.

The round dots in FIG. 4 represent peak signal amplitudes (Y axis in FIG. 4, measured in mV) expressed in the time domain as recorded using the new AE sensor 10 across the four separate tests taken at the different time instants (X axis in FIG. 4, measured in seconds), whilst the square symbols represent the same amplitudes (i.e. also peak amplitudes of the respective time signals) recorded with the old AE sensor 1.

In FIG. 4, the peak amplitudes represent the AE signals 6 obtained from the initial impact of the sphere 14 with the metal sheet 15 and are the only peak amplitudes considered herein. Other, smaller peak amplitudes could also be detected, and these were related to the bouncing of the sphere 14 after the initial impact on the metal sheet 15, and the reflections of plate waves along the metal sheet 15 (reflected by the borders of the metal sheet 15). These smaller peaks, however, were disregarded in the present comparison and are thus not shown in FIG. 4.

As clearly visible from FIG. 4, these lab tests proved that the new AE sensor 10 measured an amplitude increase in the AE signal 6 between about 12 dB and 14 dB. The background noise was also recorded in both cases (i.e., in the cases of measurements with the old and new AE sensors 1, 10) and there was a small difference between these two cases, which was consistently below + or −1.5 dB. Therefore, the new AE sensor 10 provided an overall increase of the S/N ratio within the range of about 10.5 dB to 15.5 dB—in connection with the events considered herein (i.e., the first impacts of the sphere 14 across the four tests A, B, C and D).

A second principle of the implementations described herein is the fact that the metal plate 2A also acts as a mechanical frequency filter for the incoming sound waves 9. This is due to mechanical waves travelling along the metal plate 2A, after the impact. When the incoming acoustic waves 9 impinge on the metal plate 2A, the metal plate 2A is excited to vibrate at resonant frequencies characteristic of the metal plate 2A. For a circular plate 2A, these resonant frequencies are dependent on the thickness 4 as well as the diameter 5 of the plate (or any other representative transversal dimensions, in the case of a different shape of the plate).

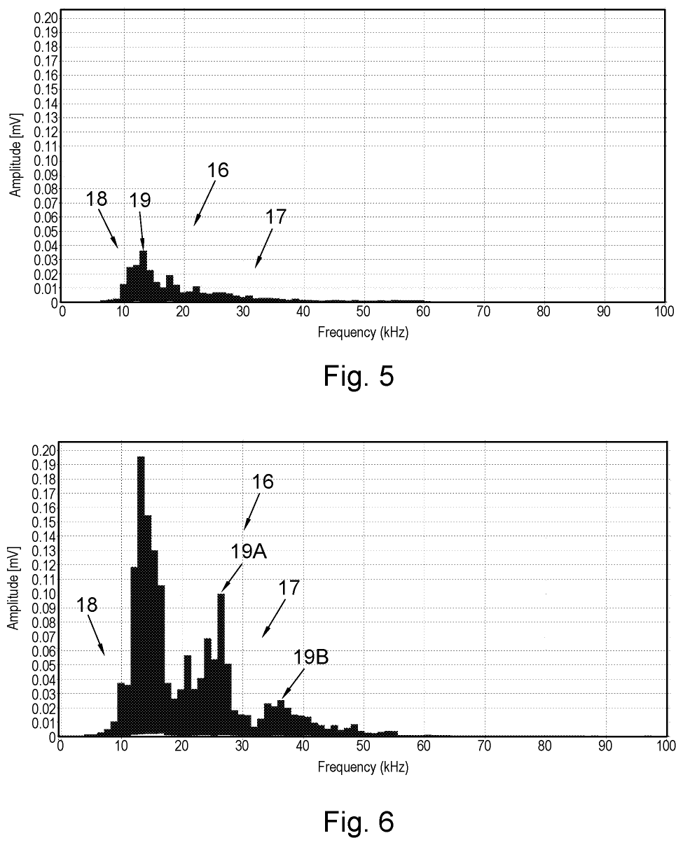

The time-domain data reported in FIG. 4 in relation to the simulated AE events were further analysed by representing the AE events in the frequency domain. FIG. 5 shows the frequency spectrum 16 of incoming acoustic waves 9 recorded using the ordinary AE sensor 1. FIG. 6 shows the frequency spectrum 16 of the same incoming wave 9 recorded using the new AE sensor 10.

Although the recorded AE signals 6 refer to the same AE event, the frequency spectra 16 of the two signals reported in FIGS. 5 and 6 are remarkably different, as shown. By using the steel plate 2A attached to the old AE sensor 1, the inventors could reduce the response at relatively low frequencies 18 (which are those which are more typically affected by many different external noise sources) and increase the response in the higher frequencies region 17, which changed the frequency spectra 16 considerably.

In other words, the metal plate 2A behaves as a transfer function which transforms the sound waves 9 in input into mechanical vibrations of the metal plate 2A in output, which mechanical vibrations are then measured by the new AE sensor 10. Not only the sound waves 9 are transformed into mechanical vibrations of the metal plate 2A, but the respective frequency spectra 16 are also changed by the metal plate 2A according to its characteristic transfer function.

As clear from FIG. 5, the AE source 8 considered herein emitted low frequencies 18 with a peak amplitude at about 15 kHz 19. The new AE sensor 10 (see FIG. 6) amplified the AE signal 6 output from the sensor at almost all frequencies in the spectrum (note that the scales in FIGS. 5 and 6 are the same), but especially in the frequency range 17 between 20 kHz and 40 kHz. Since it was desirable to cut off the low frequencies 18 from the AE signal 6 (due for example to the presence of a high level of low frequency noise), the new AE sensor 10 enabled the use of the second peak 19A in the frequency spectrum 16 of the target AE source 8 at about 27 kHz, and/or the third peak 19B at 35 kHz to successfully detect the AE event emanating from the target AE source 8, with an improved S/N ratio.

The metal plate 2A on the new AE sensor 10 thus also acts as a mechanical frequency filter (this is in addition to it acting as a mechanical signal amplitude amplifier) which can be tuned to one or more desired resonant frequencies by simply changing one or more geometric plate dimensions (such as its thickness 4, and/or diameter 5, in the case of a circular plate shape or disc shape).

The shape of the metal plate 2A, the size of its surface (i.e. the area collecting the sound waves 9) and the thickness 4 of the metal plate 2A all affect the resonant frequencies, and related maximum amplitudes of the vibration output from the metal plate 2A, and input to the new AE sensor 10. Therefore, the metal plate 2A acts as a tuneable frequency filter for the ordinary (old) AE sensor 1. The use of the metal plate 2A together with the old AE sensor 1 causes major sensor performance improvements in connection with the sensor's ability to detect the AE event. Further, the presently described solution is flexible, since the characteristics of the metal plate 2A can be easily manipulated, and the metal plate is economical.

A third principle of the present implementation is the capability of the new AE sensor 10 to shield from radiation by using the metal plate 2A. An ordinary AE sensor 1 used in a high-level radiation area may rapidly deteriorate its performance. The metal plate 2A acts as a barrier to radiation, effectively enabling an increased longevity of the new AE sensor 10.

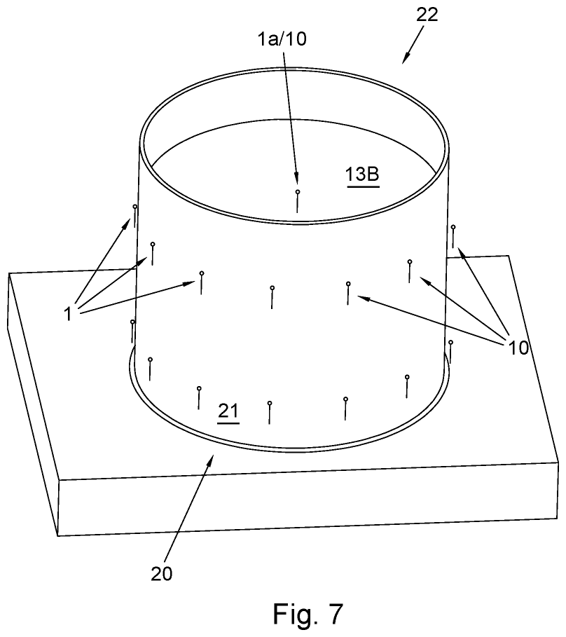

FIG. 7 shows a potential further application of the principles described herein. Fluid storage tank floors 20 are normally inspected using AE sensors 1 attached to an outside wall 21 of a tank 22 to detect acoustic emission sources 8 which typically are in the form of leaks or active corrosion on the tank floor 20, for example.

When the tank 22 is very large and the properties of a liquid 13B stored in the tank 22 are such that the acoustic waves 9 coming from the tank floor 20 are heavily attenuated before reaching the tank wall 21, where the AE sensors 1 are located, usually an additional AE sensor 1a is inserted inside the tank 22, submerged in the liquid 13B.

Such additional AE sensor 1a is at a reduced distance from enough other AE sensors 1 attached to the tank wall 21 (these could be three or four AE sensors 1, depending on the algorithms used for the ensuing calculations) such that this subset of AE sensors 1, 1a can be used to localize the AE source 8.

In the above example, it would be greatly beneficial to have a new AE sensor 10 with improved S/N performance submerged in the liquid 13, at the centre of the tank 22 to detect low amplitude sound waves 9 propagated by the target source 8. The new AE sensor 10 described herein would be ideal for this and many other cases of detection of sound waves 9 within liquid media 13B. The new AE sensor 10 would likewise be suitable for attachment to the tank wall 21 (as exemplified on the right side of FIG. 7). In this case, the mechanical amplifier 2 would be a curved plate.

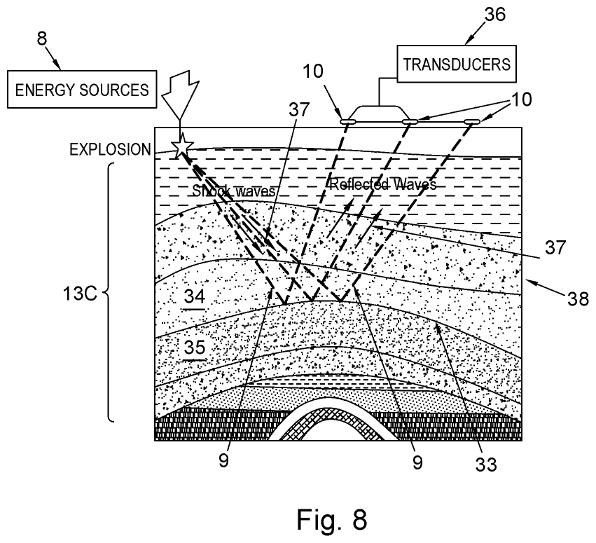

FIG. 8 shows yet a potential further application of the principles described herein. In geophysics, it is common to use large disturbances 8 of the soil 13C (including small explosions) to generate acoustic waves 9 traveling underground. These waves 9 are reflected from one or more boundaries 33 between different layers 34, 35 of the soil 13C and reach an array 36 of new AE sensors 10 placed at some distance from the initial source 8.

The new AE sensor 10 described herein would be ideal to detect, amplify and/or filter small amplitude reflections 37 previously potentially undetectable, therefore enabling a more precise mapping of large underground areas 38.

One other implementation of the principles described herein would be the construction or arrangement of a new AE sensor 10 in the form of a stack of layers comprising a mechanical amplifier 2 as one such layer, and a piezoelectric vibration-sensing element as another of the layers. The layers may be generally flat, or curved, to accommodate a convexity on an installation surface (for example the tank wall 21 described above). Optional layers may include a magnetic layer and/or a compliant layer. The magnetic layer may be integrated with the mechanical amplifier. The compliant layer would enable the installation of the new, stacked/layered AE sensor 10 on an imperfect or curved surface.

### LIST OF REFERENCE NUMBERS USED HEREIN

1,1a ordinary AE sensor
1A face of the AE sensor (wear plate)
2 mechanical amplifier
2A metal plate
3 coupling layer
3A adhesive
4 thickness
5 diameter
4, 5 representative geometric dimensions
6 AE signal (in output from the AE sensor)
7 direction of propagation
8 target AE source
9 acoustic waves (or, sound waves)
10 new or modified AE sensor
11 testing setup
12 post
13 wave propagation medium
13A air
13B liquid
13C soil
14 metal sphere
15 metal sheet
16 frequency spectrum of acoustic waves as measured by the AE sensor
17 amplified frequencies
18 attenuated frequencies
19, 19A, 19B peaks in the frequency domain
20 fluid storage tank floor
21 outside wall
22 tank
33 underground boundary
34, 35 underground layers
36 array of new AE sensors 10
37 small amplitude reflections
38 underground areas

1. An acoustic emission (AE) sensor comprising a vibration-sensing element and a mechanical amplifier, the mechanical amplifier comprising a metal plate, said metal plate having a width which is at least 2.5 times greater than any corresponding widths associated with the vibration-sensing element, and an area which is at least 5 times greater than any corresponding areas associated with the vibration-sensing element, wherein the mechanical amplifier is dynamically coupled to the vibration-sensing element upstream of the vibration-sensing element, said width and area of the metal plate being specified to increase a signal-to-noise ratio of an AE signal output by the AE sensor in response to acoustic emission generated by a target AE source.

2. The AE sensor of claim 1, wherein the plate is planar;
alternatively, wherein the plate is curved
and has an outward-facing concavity.

3. The AE sensor of claim 1, wherein the metal plate is in the shape of an ovoid, such as a disc, and a diameter of said ovoid or disc is at least 2.5 times greater than any corresponding widths, such as any corresponding diameters, associated with the AE sensor, such as any corresponding diameter of the vibration-sensing element, or a diameter of a face or a body of the AE sensor;
and wherein the metal plate has an area at least 5 times greater than any other corresponding areas associated with the AE sensor, such as the area of the vibration-sensing element, or the area of said face or body of the AE sensor.

4. The AE sensor of claim 1, wherein the AE sensor comprises one and only one vibration-sensing element;
and wherein the AE sensor comprises one and only one mechanical amplifier;
alternatively, wherein the AE sensor comprises at least two mechanical amplifiers, wherein one of said at least two mechanical amplifiers is said metal plate.

5. The AE sensor of 1, wherein said width and area of the metal plate are specified to amplify one or more first frequencies of a frequency spectrum associated with the target AE source, and/or to attenuate one or more second frequencies of the frequency spectrum associated with the target AE source.

6. The AE sensor of claim 1, wherein the metal plate has a uniform thickness.

7. The AE sensor of claim 1, wherein the metal plate is conformable for attachment to a target structure.

8. The AE sensor of claim 1, wherein the AE sensor comprises a housing adapted to accommodate the vibration-sensing element, and the metal plate is integrated into said housing.

9. The AE sensor of claim 8, wherein the metal plate is coupled to a face or side of said housing.

10. The AE sensor of claim 8, wherein the metal plate is integrally formed with the housing as a single piece, that is without showing material discontinuities between the metal plate and the remainder of the housing.

11. The AE sensor of claim 8, wherein the housing comprises a flange for connecting with the mechanical amplifier, and wherein the mechanical amplifier is removably connected to the housing via said flange.

12. The AE sensor of claim 1, wherein the AE sensor comprises a plurality of layers, wherein the metal plate and the vibration-sensitive element define respective layers within said plurality of layers.

13. The AE sensor of claim 1, wherein said vibration-sensing element is piezoelectric.

14. The AE sensor of claim 1, wherein the metal plate is constructed and arranged to shield the AE sensor against nuclear radiation.

15. An AE apparatus comprising the AE sensor according to claim 1.

16. An AE apparatus according to claim 15, wherein said AE apparatus is passive.

17. A combination of an AE sensor and a mechanical amplifier, the mechanical amplifier comprising a metal plate, said metal plate having a width which is at least 2.5 times greater than any corresponding widths associated with a vibration-sensing element of the AE sensor, and an area which is at least 5 times greater than any corresponding areas of the vibration-sensing element, wherein the mechanical amplifier is dynamically coupled or couplable to the vibration-sensing element upstream of the vibration-sensing element, and wherein said width and area of the metal plate are specified to increase a signal-to-noise ratio of an AE signal output by the AE sensor in response to acoustic emission generated by a target AE source.

18. A method of detecting acoustic emission from a target AE source, the method comprising:
deploying the AE sensor of claim 1.

19. The method of claim 18, wherein the AE sensor is deployed in a fluid medium, such as a gas or a liquid, or in/on a solid medium.

20. A non-destructive testing method comprising the method of claim 18.

21. A nuclear facility inspection method comprising the method of claim 20.

22. A storage tank inspection method comprising the method of claim 20.

23. A geophysical inspection method comprising the method of claim 18.

24. A sonar inspection method comprising the method of claim 18.

25. A method of retrofitting an AE sensor, the method comprising:
providing an AE sensor; and
fitting a mechanical amplifier to the AE sensor, wherein the mechanical amplifier comprises a metal plate, said metal plate having a width which is at least 2.5 times greater than any corresponding widths associated with a vibration-sensing element of the AE sensor, and an area which is at least 5 times greater than any corresponding areas associated with the vibration-sensing element, whereby the metal plate is dynamically coupled to the vibration-sensing element upstream of the vibration-sensing element, wherein said width and area of the metal plate are specified to increase a signal-to-noise ratio of an AE signal output by the AE sensor in response to acoustic emission generated by a target AE source.

26. A method of measuring acoustic emission, the method comprising:
providing an AE sensor;
specifying a width and an area for a mechanical amplifier so as to increase a signal-to-noise ratio of an AE signal output by the AE sensor in response to acoustic emission generated by a target AE source, wherein the mechanical amplifier is in the form of a metal plate having a width which is at least 2.5 times greater than any corresponding widths associated with a vibration-sensing element of the AE sensor, and an area which is at least 5 times greater than any corresponding areas of the vibration-sensing element;
independently of the provision of the AE sensor, providing said mechanical amplifier; and,
dynamically coupling the mechanical amplifier to the vibration-sensing element by fitting the mechanical amplifier to the AE sensor.
